(19) United States
(12) Patent Application Publication
(10) Pub. No.: US 2025/0013961 A1
(43) Pub. Date: Jan. 9, 2025

(54) METHOD FOR ANALYZING CHANGES IN URBAN ECONOMIC DEVELOPMENT CHARACTERISTICS OF URBAN AGGLOMERATION BASED ON NIGHTTIME LIGHT REMOTE SENSING

(71) Applicant: CHENGDU UNIVERSITY OF TECHNOLOGY, Chengdu City (CN)

(72) Inventors: Xin YANG, Chengdu City (CN); Zhensheng NIU, Chengdu City (CN); Xiang LIAO, Chengdu City (CN); Wenfu HOU, Chengdu City (CN); Chuanxiang DENG, Chengdu City (CN)

(73) Assignee: CHENGDU UNIVERSITY OF TECHNOLOGY, Chengdu City (CN)

(21) Appl. No.: 18/630,500

(22) Filed: Apr. 9, 2024

(30) Foreign Application Priority Data
Jul. 6, 2023 (CN) 202310825573.7

(51) Int. Cl. G06Q 10/0637

(52) U.S. Cl. CPC G06Q 10/0637

(57) ABSTRACT

Disclosed is a method for analyzing changes in urban economic development characteristics of an urban agglomeration based on nighttime light remote sensing according, including: building a Gross Domestic Product (GDP) spatialization model: spatializing GDP of an urban agglomeration region by using an industry-based modeling approach, modeling spatialization of a primary industry output GDP₁ with land use data, and modeling spatialization of a secondary and tertiary industry output GDP₂₃ by selecting an optimal light index on the basis of nighttime light data; measuring an increase or a decrease of a specific variable over time at a pixel level using trend analysis; and modifying a gravity model that reflects an economic linkage strength between cities. The present disclosure can provide data support and methodological basis for the high-quality economic development of the urban agglomeration.

### CROSS REFERENCE TO RELATED APPLICATION

This patent application claims the benefit and priority of Chinese Patent Application No. 202310825573.7, filed with the China National Intellectual Property Administration on Jul. 6, 2023, the disclosure of which is incorporated by reference herein in its entirety as part of the present application.

### TECHNICAL FIELD

The present disclosure relates to the technical field of urban economic development in an urban agglomeration, and in particular, to a method for analyzing changes in urban economic development characteristics of an urban agglomeration based on nighttime light remote sensing.

### BACKGROUND

Gross Domestic Product (GDP) is one of the important indicators for measuring the development status and economic development level of a country or region^{[1]}. Previous GDP data were macroscopic data collected by administrative units, lacking spatial information and having a long release cycle, making it difficult to reflect spatial differences and dynamic changes in regional development. Therefore, spatializing socio-economic data and exploring regional economic development levels and development differences at macro and micro scales have become extremely important^{[2]}.

Nighttime light is closely related to urban economy. In recent years, many scholars have conducted research on nighttime light data and GDP, producing a large number of effective works. As early as 1997, Elvidge et al.^{[3]} used the Defense Meteorological Satellite Program's Operational Linescan System (DMSP/OLS) to study 21 countries and found a strong correlation between nighttime light intensity and GDP. In recent years, with the release of a new generation of nighttime light data, i.e., National Polar-Orbiting Partnership's Visible Infrared Imaging Radiometer Suite (NPP/VIIRS), which has a higher spatial resolution and a wider radiation range, the accuracy of GDP spatialization has been further improved. Li et al.^{[4]} compared the relationships between the two types of light data and GDP, and found that compared with the DMSP/OLS data, the NPP/VIIRS data has a significantly stronger correlation with GDP.

Exploring the spatial connection of high-quality economic development in an urban agglomeration is of great significance for identifying the spatial orientation of high-quality economic development among cities within the urban agglomeration and promoting the high-level integrated development of the urban agglomeration. Zhu Yongming et al.^{[5]} used the entropy method and constructed a modified gravity model to analyze the level of high-quality economic development and its spatial connections in the Central Plains urban agglomeration. Wang Sha et al.^{[6]}, based on the comprehensive use of the urban functional intensity model, gravity model, and urban flow model, described the economic spatial connection characteristics within the Beijing-Tianjin-Hebei urban agglomeration. Currently, relevant research has achieved certain results in studying the spatial connections among urban agglomeration economies, but most of them use traditional survey data, and there is little research combining nighttime light data. Moreover, many studies consider the economic linkage between two cities as symmetric, ignoring the differences in the development of the two cities.
[1] WANG Qi, YUAN Tao, ZHENG Xinqi, GDP Gross Analysis at Province-Level in China Based on Night-Time Light satellite Imagery [J]. Urban Development Studies, 2013, 20(07):44-48.
WANG Qi, YUAN Tao, ZHENG Xinqi, GDP Gross Analysis at Province-Level in China Based on Night-Time Light satellite Imagery [J]. Urban Development Studies, 2013, 20(07):44-48.
[2] WANG Xu, WU Jidong, WANG Hai, et al. Comparison of GDP Spatialization in Beijing-Tianjin-Hebei Based on Night Light and Population Density Data [J]. Journal of Geo-Information Science, 2016, 18(07):969-976.
WANG Xu, WU Jidong, WANG Hai, et al. Comparison of GDP Spatialization in Beijing-Tianjin-Hebei Based on Night Light and Population Density Data [J]. Journal of Geo-Information Science, 2016, 18(07):969-976.
[3] Elvidge C D, Baugh K E, Kihn E A, et al. Relation between satellite observed visible-near infrared emissions, population, economic activity and electric power consumption[J]. International journal of remote sensing. 1997, 18(6): 1373-1379.
[4] Li X, Xu H, Chen X, et al. Potential of NPP-VIIRS Nighttime Light Imagery for Modeling the Regional Economy of China [J]. Remote Sensing. 2013, 5(6): 3057-3081.
[5] ZHU Yongming, JIA Zongya. Research on the Spatial Connections and Characteristics of High-Quality Economic Development of Cities: A Case Study of the Central Plains Urban Agglomeration [J]. Ecological Economy, 2022, 38(12):82-88.
ZHU Yongming, JIA Zongya. Research on the Spatial Connections and Characteristics of High-Quality Economic Development of Cities: A Case Study of the Central Plains Urban Agglomeration [J]. Ecological Economy, 2022, 38(12):82-88.
[6] Wang Sha, Tong Lei, He Yude. Quantitative Measurement of Economic Linkages between Beijing-Tianjin-Hebei Urban Agglomeration [J]. Technology Economics, 2019, 38(10):74-81.
Wang Sha, Tong Lei, He Yude. Quantitative Measurement of Economic Linkages between Beijing-Tianjin-Hebei Urban Agglomeration [J]. Technology Economics, 2019, 38(10):74-81.

### SUMMARY

To address the problems in the prior art, an objective of the present disclosure is to provide a method for analyzing changes in urban economic development characteristics of an urban agglomeration based on nighttime light remote sensing. The present disclosure can provide data support and methodological basis for the high-quality economic development of urban agglomerations.

To achieve the foregoing objective, the present disclosure employs the following technical solution: a method for analyzing changes in urban economic development characteristics of an urban agglomeration based on nighttime light remote sensing, including the following steps:
step 1: building a GDP spatialization model: spatializing GDP of an urban agglomeration region by using an industry-based modeling approach, modeling spatialization of a primary industry output GDP₁ with land use data, and modeling spatialization of a secondary and tertiary industry output GDP₂₃ by selecting an optimal light index on the basis of nighttime light data;
step 2: measuring an increase or a decrease of a specific variable over time at a pixel level using trend analysis, which is specifically as follows:

$${θ}_{slope} = \frac{n \times {\sum }_{i = 1}^{n} ( i \times {GDP}_{i} ) - {\sum }_{i = 1}^{n} i {\sum }_{i = 1}^{n} {GDP}_{i}}{n \times {\sum }_{i = 1}^{n} {i}^{2} - {( {\sum }_{i = 1}^{n} i )}^{2}}$$

where θₛₗₒₚₑ represents a slope of a univariate linear regression equation for year-to-year change of GDP in a corresponding time period at a current pixel, n represents a detection time span in years, and GDPᵢ represents a GDP value of year i;
step 3: modifying a gravity model that reflects an economic linkage strength between cities: modifying a gravity constant based on a ratio of comprehensive quality of one city to total comprehensive quality of two cities; expressing a spatial distance between the cities in the form of a time distance; reflecting a degree of balance of economic and social development within each city by using a night light development index (NLDI); and for each city, using GDP and a reciprocal of the NLDI as a measure of comprehensive urban development quality:

$${R}_{ij} = {k}_{ij} \frac{{V}^{r} {M}_{i} {M}_{j}}{{D}_{ij}^{r}}$$

$${M}_{i} = \sqrt{\frac{{GDP}_{i}}{{NDLI}_{i}}}$$

$${k}_{ij} = \frac{{M}_{i}}{{M}_{i} + {M}_{j}}$$

where Rᵢⱼ is an economic linkage level between city i and city j; Mᵢ and Mⱼ are comprehensive development quality of the two cities; kᵢⱼ is a modified gravity coefficient; Dᵢⱼ is a shortest highway distance between city i and city j; V is a highway travel speed in a research area; r is a friction coefficient; GDPᵢ is simulated GDP of city i; NDLIᵢ is a night light development index of city i.

As a further improvement of the present disclosure, in step 1, modeling the spatialization of the primary industry output GDP₁ with land use data specifically includes:
modeling GDP₁ by selecting arable land and woodland, specifically as follows:

$${GDP}_{1 n} = a \cdot {S}_{c}$$

where GDP₁ₙ is a primary industry output of year n; S_{c} is a sum of arable land and woodland areas; and a is a coefficient of a regression model.

As a further improvement of the present disclosure, in step 1, modeling the spatialization of the secondary and tertiary industry output GDP₂₃ by selecting the optimal light index on the basis of the nighttime light data specifically includes:
calculating nighttime light indices for multiple prefecture-level cities over multiple years in the urban agglomeration region, and performing regression analysis on the nighttime light indices with respect to GDP₂₃ to select the optimal light index, where a specific parameter model is as follows:

$${GDP}_{23 n} = {P}_{0} + a \times {Q}_{i}$$

where GDP₂₃ₙ represents a secondary and tertiary industry output of year n; P₀ is a constant; a is a coefficient of a regression model; and Qᵢ represents light indices; and
calculating nighttime light indices over the years, performing correlation analysis on the nighttime light indices and GDP₂₃, and selecting a light index with a highest correlation to establish a regression model with GDP₂₃.

As a further improvement of the present disclosure, the light indices include total nighttime light (TNL), average light intensity (ALI), and compounded night light index (CNLI):

$$NL = {\sum }_{i = 0.3}^{{DN}_{max}} ( {DN}_{i} \times {n}_{i} )$$

$$ALI = \frac{TNL}{{DN}_{max} \times N}$$

$$S = \frac{{A}_{N}}{A}$$

$$CNLI = ALI \times S$$

where DNᵢ and nᵢ represent a grayscale pixel value and the number of pixels at an i-th level within an administrative unit, respectively; DNₘₐₓ represents a maximum pixel value within the administrative unit; N is a total number of pixels with light values in a range of [0.3, DNₘₐₓ] within the region; S is a light area ratio; A_{N} represents an area occupied by the pixels in the range of [0.3,DNₘₐₓ] in the administrative unit, and A represents an area of the administrative unit.

As a further improvement of the present disclosure, step 1 further includes linear correction of GDP, where under the condition of ensuring that total actual statistical GDP of all cities in the urban agglomeration remains unchanged, pixel-wise correction is performed using the following formula:

$${GDP}_{T} = {GDP}_{j} \times ( {GDP}_{t} / {GDP}_{all} )$$

where GDP_{T} is a simulated GDP value after the pixel-wise correction; GDPⱼ is an initial simulated value for each pixel; GDPₜ is an actual statistical GDP value of each city; and GDPₐₗₗ is a total simulated GDP value of all the cities.

As a further improvement of the present disclosure, the method further includes performing precision verification on the corrected GDP by using a relative error (RE) and a mean relative error (MRE), which is specifically as follows:

$$RE = ( \vert \frac{{GDP}_{S} - {GDP}_{A}}{{GDP}_{A}} \vert ) \times 100 \%$$

$$MRE = \frac{1}{n} RE$$

where GDP_{S} represents a simulated GDP value, GDP_{A} represents an actual statistical GDP value, and n is the number of prefecture-level cities.

The method of the present disclosure for analyzing changes in economic development characteristics based on NPP/VIIRS nighttime light data includes: obtaining annual raw NPP/VIIRS nighttime light data, and preprocessing the data to obtain annual corrected NPP/VIIRS nighttime light data; constructing total nighttime light (TNL), average light intensity (ALI), and compounded night light index (CNLI), spatializing economic data of the research area using land use data, verifying the accuracy and performing linear correction, and using trend analysis to analyze the distribution and development of urban economy at the pixel scale; constructing new comprehensive urban development quality by introducing a night light development index (NLDI), to modify the gravity model, and comparing the improved modified gravity model with the traditional model for advantage analysis, and analyzing characteristics of an urban economic network structure at the macro scale; and based on the above two scales, comprehensively analyzing changes in urban economic development characteristics. The model constructed in the present disclosure addresses issues of traditional economic data such as the lack of spatial information and difficulties in reflecting spatial differences and dynamic changes in regional economic development. Additionally, the modified gravity model constructed in the present disclosure clarifies the bidirectional gravity differences between cities that are often overlooked in the current research, better reflecting the level of economic interaction between cities.

The present disclosure has following beneficial effects:

The present disclosure spatializes GDP of various regions in an urban agglomeration over different years by using nighttime light data, land use data, and socio-economic data. The economic development characteristics of the Chengdu-Chongqing urban agglomeration at both the pixel level and economic linkage level are analyzed using trend analysis in combination with the modified gravity model improved based on the nighttime light index. This provides data support and methodological basis for the high-quality economic development of the urban agglomeration.

### BRIEF DESCRIPTION OF THE DRAWINGS

FIG. 1 is a flowchart of an embodiment of the present disclosure;

FIG. 2 illustrates nighttime light radiation values and topography in a research area in 2020 according to an embodiment of the present disclosure;

FIGS. 3A-3C are schematic diagram of regression analysis fitting results of a sum of arable land and woodland areas against GDP₁ according to an embodiment of the present disclosure;

FIGS. 4A-4C are schematic diagram of regression analysis fitting results of a nighttime light index TNL against GDP₂₃ according to an embodiment of the present disclosure;

FIG. 5 is a schematic diagram of DNLI distribution of cities in the Chengdu-Chongqing region in 2014, 2017, and 2020 according to an embodiment of the present disclosure;

FIGS. 6A-6C are schematic diagram of a spatial distribution of GDP density in the Chengdu-Chongqing region according to an embodiment of the present disclosure;

FIG. 7 is a schematic diagram of relative errors between predicted GDP values and actual GDP values for each city according to an embodiment of the present disclosure;

FIGS. 8A-8C are schematic diagram of fitting between predicted GDP values and actual GDP values according to an embodiment of the present disclosure;

FIGS. 9A-9C are schematic diagram of an evolution trend of GDP distribution from 2014 to 2020 according to an embodiment of the present disclosure;

FIG. 10 is a schematic diagram of Mᵢ values and proportions in the Chengdu-Chongqing urban agglomeration from 2014 to 2020 according to an embodiment of the present disclosure; and

FIGS. 11A-11F are schematic diagram of economic linkage strength between cities in the Chengdu-Chongqing region according to an embodiment of the present disclosure.

### DETAILED DESCRIPTION OF THE EMBODIMENTS

The embodiments of the present disclosure are described in detail below with reference to the accompanying drawings.

### Embodiment

In recent years, bolstered by a series of national policies such as the Western Development, the Chengdu-Chongqing urban agglomeration has become one of the regions in Western China with higher development levels and stronger economic capabilities. Based on this, this embodiment takes the years 2014, 2017, and 2020 as the research time frames. A GDP spatialization model is constructed by using nighttime light data, land use data, and socio-economic data, and trend analysis is applied to analyze the economic distribution and development status of the Chengdu-Chongqing region at the pixel level. The method for evaluating comprehensive urban development quality is refined by incorporating a nighttime light index into the comprehensive urban quality and then using the index as a quality variable in the modified gravity model. The economic network structure between cities in the Chengdu-Chongqing region is analyzed at a macro level. This enhances the comprehensive understanding of the urban development system, providing decision-making support for the construction of the Chengdu-Chongqing economic circle and high-quality development in the Chengdu-Chongqing region, and also providing a theoretical reference for subsequent policy formulation in the Chengdu-Chongqing region.

To address issues in traditional economic data such as the lack of spatial information and difficulties in reflecting spatial differences and dynamic characteristics of regional economic development, this embodiment constructs a GDP spatialization model for the Chengdu-Chongqing region by using nighttime light data, land use data, and socio-economic data. Methods such as trend analysis and modified gravity model are employed to analyze the economic development characteristics at the pixel scale and in terms of economic linkages. Results indicate that the GDP spatialization model constructed based on multi-source data has high accuracy, with errors not exceeding 1.1%. Areas with rapid growth in GDP density in the Chengdu-Chongqing region are mainly located around the main urban areas of Chengdu and Chongqing, accounting for approximately 73.9%, and these areas also demonstrate prominent economic agglomeration characteristics. The economic linkage strength between cities in the Chengdu-Chongqing region continues to deepen, and the comprehensive quality of urban development steadily improves, with Chengdu having the closest economic ties with its surrounding cities. In summary, the regional economy in the Chengdu-Chongqing region exhibits a spatial characteristic of “dual-core-driven development,” with an increasing economic linkage strength. This research can provide data support and methodological basis for the high-quality development of the Chengdu-Chongqing urban agglomeration.

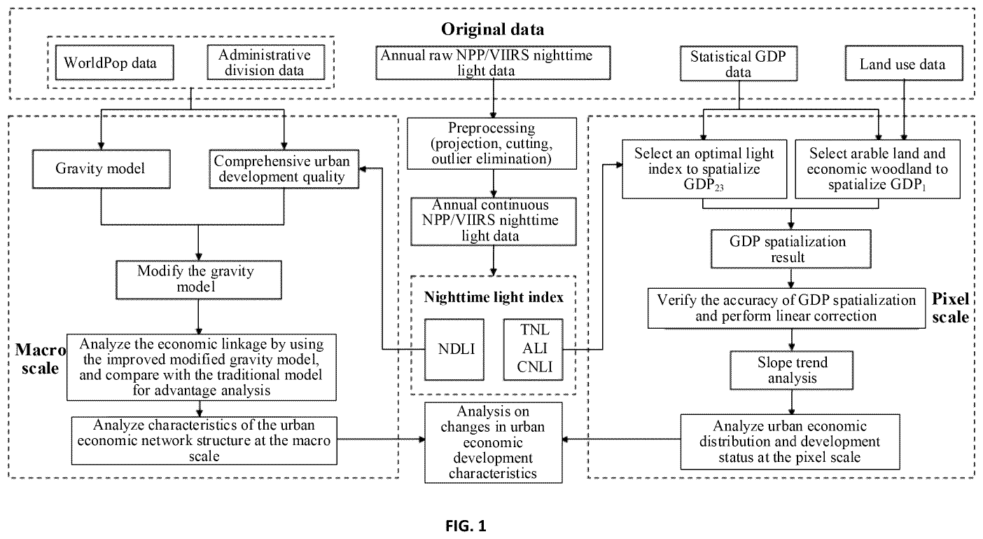

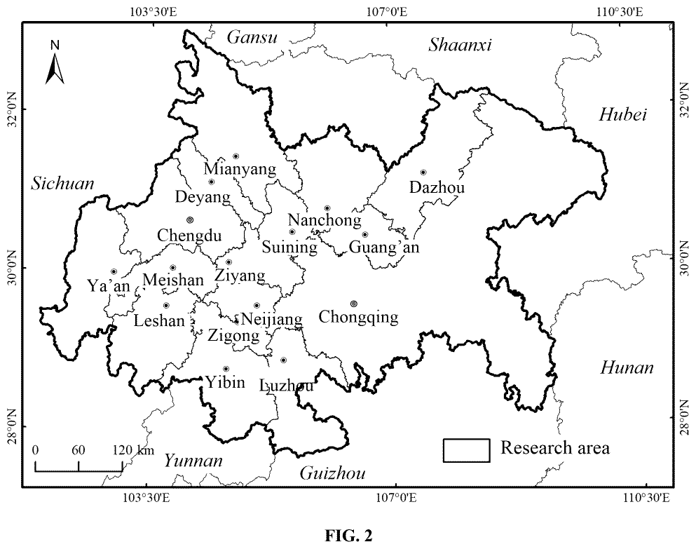

Based on this, as shown in FIG. 1 and FIG. 2, this embodiment specifically uses the Chengdu-Chongqing urban agglomeration as an example for illustration, providing a method for analyzing changes in urban economic development characteristics of an urban agglomeration based on nighttime light remote sensing. The method is as follows:

### I. Research Area and Data Sources:

### Overview of the Research Area:

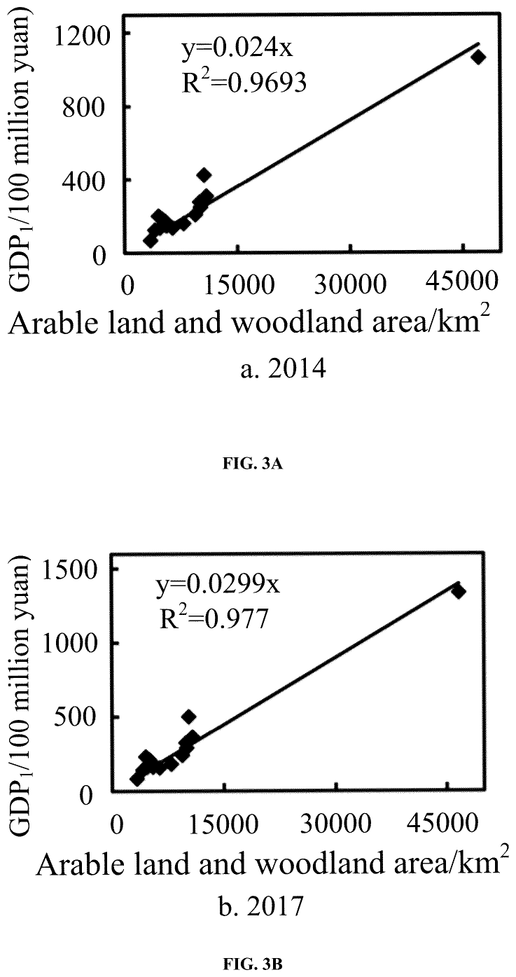

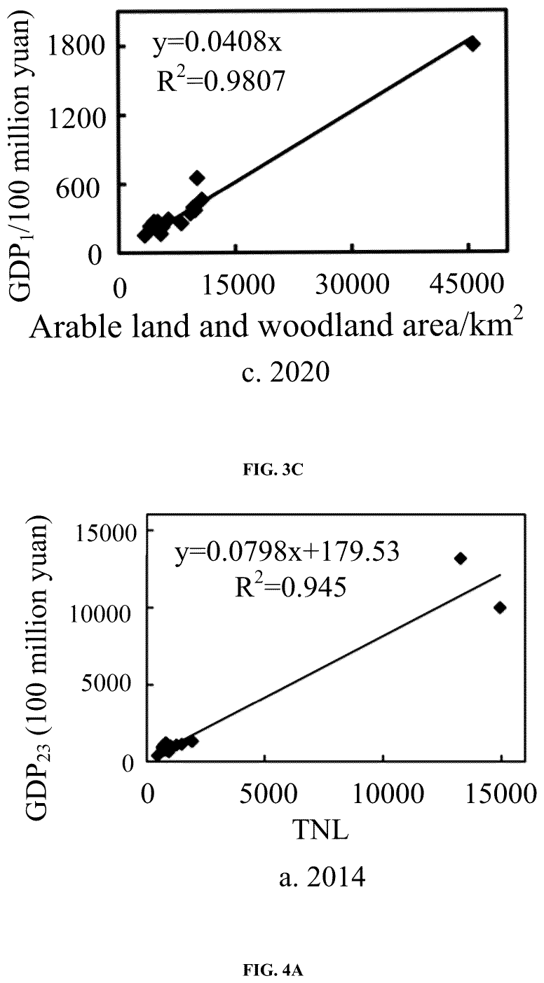

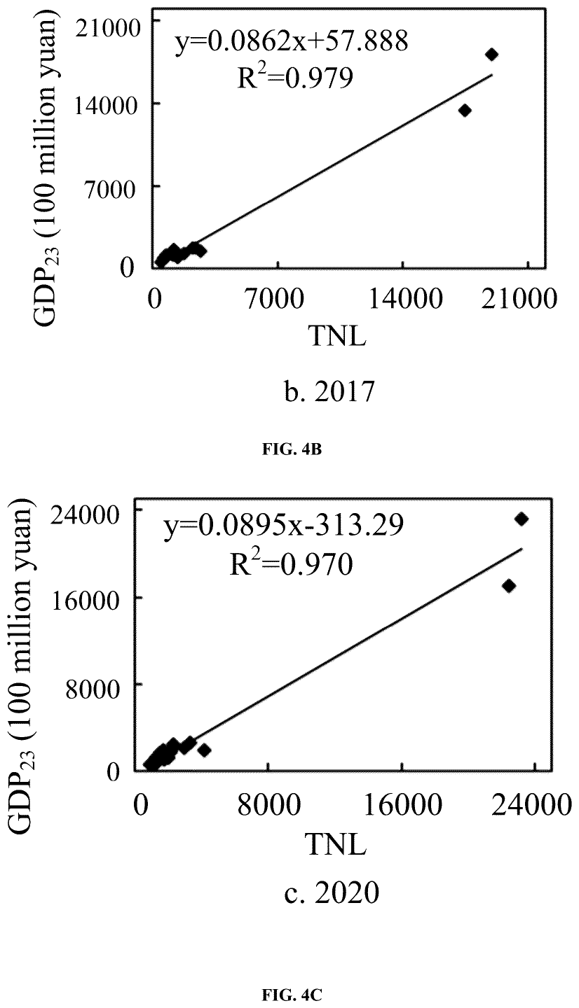

The Chengdu-Chongqing urban agglomeration is located in the southwestern part of China, at the latitudes 27°40′-33°3′N and longitudes 101°55′-109°40′E. It mainly experiences a subtropical monsoon climate and serves as the joint zone for the Yangtze River Economic Belt and the Silk Road Economic Belt. It is also the region with the highest population density and the most robust industrial foundation in the western part of the country. According to the Chengdu-Chongqing Urban Agglomeration Development Plan issued by the National Development and Reform Commission, the Chengdu-Chongqing urban agglomeration includes 27 districts (counties) in Chongqing and 15 prefecture-level cities in Sichuan, covering a total area of 185,000 square kilometers. This embodiment considers all 15 prefecture-level cities in Sichuan and all districts (counties) included in Chongqing as the research area, as shown in FIGS. 3A-3C.

### 2. Data Sources and Processing:

### 2.1 GDP Statistical Data:

The social and economic data for the years 2014, 2017, and 2020 used in this embodiment are sourced from the “Statistical Yearbook of Sichuan Province” and the “Statistical Yearbook of Chongqing Municipality,” as well as statistical yearbooks of various cities, counties, and districts and statistical bulletins. These data are compiled into corresponding tables according to the years and regions.

### 2.2 NPP/VIIRS Nighttime Light Data:

The NPP/VIIRS nighttime light data are obtained from the annual average images for the years 2014, 2017, and 2020 released by the National Oceanic and Atmospheric Administration of the United States (https://www.ngdc.noaa.gov/eog). These images are captured by the Visible Infrared Imaging Radiometer Suite (VIIRS) sensor onboard the Suomi-NPP satellite, with a spatial resolution of approximately 500 meters. The satellite employs a wide-angle radiometer, which eliminates the oversaturation of light in DMSP/OLS images, enhances detection sensitivity, and makes it easier to detect faint light in rural areas and excessively bright light in urban centers. Since the raw data are not processed, operations such as outlier elimination and continuity correction need to be performed on the data. Finally, the NPP/VIIRS data are transformed into Lambert projection coordinates, resampled to 500 m×500 m, and clipped to the desired extent based on vector data of the Chengdu-Chongqing region.

### 2.3 Land Use Data:

The land use data used in this embodiment are derived from annual China Land Cover Dataset (CLCD) from 1985 to 2020 created by Yang Jie using Landsat images based on the random forest method, with a resolution of 30 meters. The data are extracted to the research area using a mask, and after transformation and projection, the area of each land use type is extracted based on counties (cities/districts).

### 2.4 WorldPop Data:

Population data are sourced from the WorldPop official website (https://hub.worldpop.org/), with a spatial resolution of 100 meters. The data have high spatial resolution and population fitting accuracy. The data are extracted based on the administrative regions of the Chengdu-Chongqing area using ArcGIS software and organized into Excel spreadsheets.

### II. Research Method:

### 1. Construction of GDP Spatialization Model:

In recent years, with the widespread application of nighttime light data, the method of spatializing GDP based on nighttime light data has become increasingly mature, and using nighttime light data in conjunction with other data for GDP spatialization has become a new research direction. Modeling socio-economic spatialization by industry based on land use data can significantly improve modeling accuracy. Therefore, this embodiment adopts an industry-based modeling method to spatialize GDP of the Chengdu-Chongqing region. A primary industry output (GDP₁) is spatialized using land use data; a secondary and tertiary industry output (GDP₂₃) is spatialized by selecting an optimal light index on the basis of nighttime light data.

### 1.1 Construction of Primary Industry Output Spatialization Model:

Existing literature has shown that there is not a high correlation between the primary industry and nighttime light data, and this it is unsuitable to spatialize the primary industry output using the nighttime light data. The primary industry primarily depends on agriculture, forestry, animal husbandry, and fisheries, corresponding to land use types of arable land, woodland, grassland, and water bodies. Through an analysis of land use types in the Chengdu-Chongqing region, it is evident that this region is dominated by arable land and woodland, which together account for over 98% of the four land use types mentioned above. Therefore, in this embodiment, arable land and woodland are selected to model GDP₁. However, not all woodlands contribute to the primary industry output. In this embodiment, based on the research by Li Feng and others, combined with actual conditions, woodlands with aspects between 90° and 270° and slopes less than 20° are identified using GIS overlay analysis and extracted. These woodlands are considered economic woodlands (referred to as woodlands in the following) for the study.

Taking the year 2020 as an example, a multiple linear regression analysis is conducted on areas of arable land and woodland with respect to GDP₁. Regression coefficients a and b corresponding to the arable land and woodland are 0.006 and 0.05, with R² being 0.971. An analysis of the correlation between a sum of arable land and woodland areas and GDP₁ is also performed, and it is found that R² is 0.9807, indicating a strong correlation. This suggests that modeling GDP₁ using the sum of arable land and woodland areas is also feasible. Furthermore, a regression analysis is performed on the sum of arable land and woodland areas with respect to GDP₁ for the years 2014 and 2017, and the regression relationship is shown in FIGS. 3A-3C, which also demonstrates a good fit. Therefore, this embodiment uses the following formula to model GDP₁: The formula is as follows:

$${GDP}_{1 n} = a \cdot {S}_{c}$$

where GDP₁ₙ is a primary industry output of year n; S_{c} is a sum of arable land and woodland areas; and a is a coefficient of a regression model.

### 1.2 Construction of Secondary and Tertiary Industry Output Spatialization Model:

Due to the similarity in urban light intensity between the secondary and tertiary industries, it is feasible to integrate the secondary and tertiary industries as a single variable for correlation analysis.

Currently, the following three light indices are commonly used to reflect the level of socio-economic development in a specific region: Total Night-time Light (TNL), Average Light Intensity (ALI), and Compounded Night Light Index (CNLI). The formula is as follows:

$$NL = {\sum }_{i = 0.3}^{{DN}_{max}} ( {DN}_{i} \times {n}_{i} )$$

$$ALI = \frac{TNL}{{DN}_{max} \times N}$$

$$S = \frac{{A}_{N}}{A}$$

$$CNLI = ALI \times S$$

where DNᵢ and nᵢ represent a grayscale pixel value and the number of pixels at an i-th level within an administrative unit, respectively; DNₘₐₓ represents a maximum pixel value within the administrative unit; N is a total number of pixels with light values in a range of [0.3, DNₘₐₓ] within the region; S is a light area ratio; A_{N} represents an area occupied by the pixels in the range of [0.3, DNₘₐₓ] in the administrative unit, and A represents an area of the administrative unit.

Nighttime light indices TNL, ALI, and CNLI of 16 prefecture-level cities in the Chengdu-Chongqing region over the years 2014, 2017, and 2020 are calculated, and regression analysis is performed on the nighttime light indices with respect to GDP₂₃ to select an optimal light index, where a specific parameter model is as follows:

$${GDP}_{23 n} = {P}_{0} + a \times {Q}_{i}$$

where GDP₂₃ₙ represents a secondary and tertiary industry output of year n; P₀ is a constant; a is a coefficient of a regression model; and Qᵢ represents the three light indices mentioned above (TNL, ALI, and CNLI).

Nighttime light indices over the years are calculated, and correlation analysis is performed on the nighttime light indices and GDP₂₃ (Table 1). The results show that GDP₂₃ has the strongest correlation with TNL, with correlation coefficients up to 0.972, 0.989, and 0.985, while the correlation with ALI is the weakest, with coefficients of only 0.018, 0.152, and 0.189.

TABLE 1
Fit relationships between the three light indices and GDP₂₃

| | Correlation coefficient | | | Fit accuracy | | |
|---|---|---|---|---|---|---|
| Year | TNL | ALI | CNLI | TNL | ALI | CNLI |
| 2014 | 0.972 | 0.018 | 0.42 | 0.945 | 0.003 | 0.176 |
| 2017 | 0.989 | 0.152 | 0.459 | 0.979 | 0.023 | 0.21 |
| 2020 | 0.985 | 0.189 | 0.455 | 0.97 | 0.036 | 0.207 |

Based on the above validation, the light index TNL (Total Night-time Light), which exhibits the highest correlation, is selected, and a regression model between TNL and GDP₂₃ is established, where the scatter plot is shown in FIG. 5.

### 1.3 GDP Linear Correction:

Due to significant errors in simulated GDP calculated based on the combination of light data and land use data, a pixel-wise correction is conducted while ensuring the total GDP of each district/county remains unchanged. The following formula is used for the pixel-wise correction: The formula is as follows:

$${GDP}_{T} = {GDP}_{j} \times ( \frac{{GDP}_{t}}{{GDP}_{a l l}} )$$

where GDP_{T} is a simulated GDP value after the pixel-wise correction; GDPⱼ is an initial simulated value for each pixel; GDPₜ is an actual statistical GDP value of each county (district); and GDPₐₗₗ is a total simulated GDP value of all counties (districts).

To validate the difference between the corrected GDP fitting results and the original statistical results, a relative error (RE) and a mean relative error (MRE) are utilized in this embodiment for accuracy verification of the GDP after pixel-wise correction. The formula is as follows:

$$RE = ( \vert \frac{{GDP}_{S} - {GDP}_{A}}{{GDP}_{A}} \vert ) \times 100 \%$$

$$MRE = \frac{1}{n} RE$$

where GDPs represents the simulated GDP value, GDP_{A} represents the actual statistical GDP value, and n is the number of prefecture-level cities.

### 2. Trend Analysis:

Trend analysis can measure the increase or decrease of a variable at the pixel level over time, effectively reflecting the change trend of the variable. The formula is as follows:

$${θ}_{slope} = \frac{n \times {\sum }_{i = 1}^{n} ( i \times {GDP}_{i} ) - {\sum }_{i = 1}^{n} i {\sum }_{i = 1}^{n} {GDP}_{i}}{n \times {\sum }_{i = 1}^{n} {i}^{2} - {( {\sum }_{i = 1}^{n} i )}^{2}}$$

where θ represents a slope of a univariate linear regression equation for year-to-year change of GDP in a corresponding time period at a current pixel, n represents a detection time span in years, and GDP₁ represents a GDP value of year i.

### 3. Modification of Gravity Model:

The gravity model is constructed based on the principles of universal gravitation and distance decay. While the traditional gravity model provides a scientific basis for revealing the strength and direction of spatial connections between different cities, it has some limitations. The traditional gravity model assumes that the linkage between two cities is symmetric, which may not be the case in urban development. Additionally, the traditional gravity model typically uses a straight-line geographic distance between two locations, which may not accurately reflect an actual distance between the two locations due to geographical constraints and other factors. Furthermore, existing studies often use population and GDP to characterize comprehensive urban quality, lacking a comprehensive understanding of urban development systems. To address these issues, this embodiment makes some improvements to the traditional gravity model.

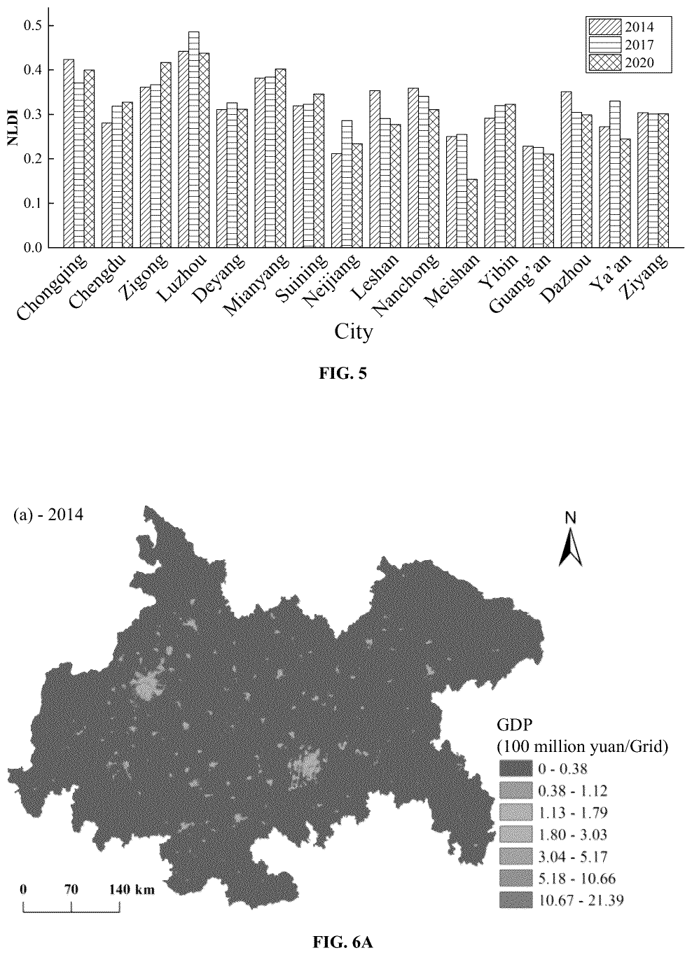

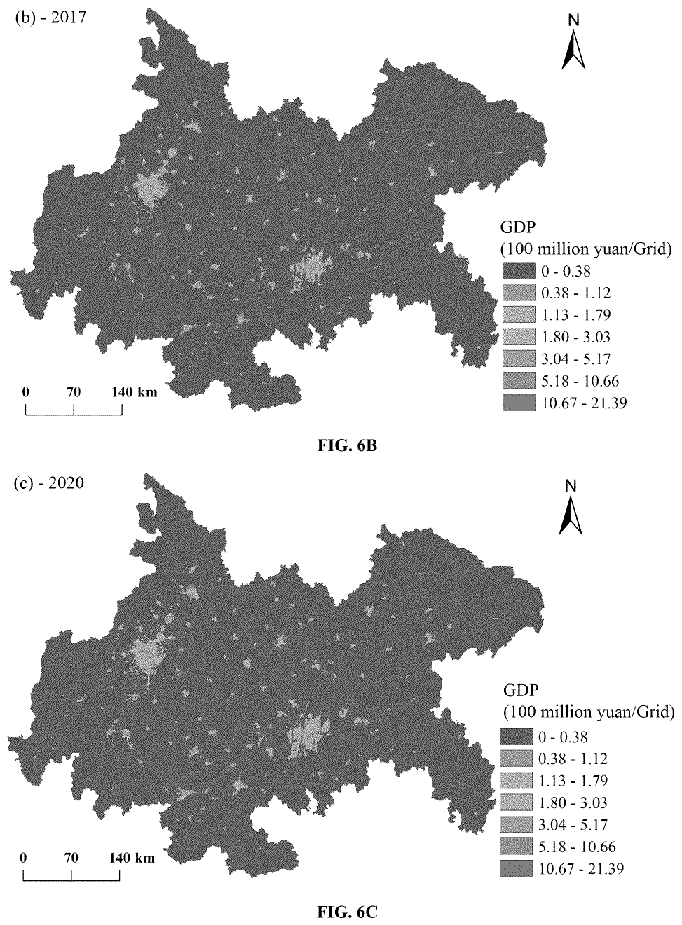

Considering the influence of the comprehensive strength between cities, the economic development type of cities may exhibit spillover and absorption effects, which can interfere with the strength of economic connectivity between cities. Therefore, this embodiment constructs a ratio of comprehensive quality of one city to total comprehensive quality of two cities to modify the gravity constant. Secondly, in the context of increasingly close connectivity and continuous improvement of infrastructure within urban agglomerations, it's more reasonable to express the spatial distance between cities in terms of time distance. The highway network in the Chengdu-Chongqing region is well-developed. In this embodiment, the shortest highway distance between each pair of cities is retrieved using Baidu API, assuming a travel speed of 100 km/h. The night light development index (NLDI) created by Elvidge et al. can reflect the balance of economic and social development within cities, with NLDI values ranging from 0 to 1. A value closer to 0 indicates a more balanced distribution of night light and population within the region, while a value closer to 1 indicates a more uneven distribution. FIGS. 6A-6C show NLDI values for various cities in the Chengdu-Chongqing region. In this embodiment, the GDP and the reciprocal of the NLDI of each prefecture-level city are used as a measure of the comprehensive urban development quality, better reflecting the degree of balance of urban development and enhancing the comprehensive understanding of urban development systems.

$${R}_{i j} = {k}_{i j} \frac{{V}^{r} {M}_{i} {M}_{j}}{{D}_{i j}^{r}}$$

$${M}_{i} = \sqrt{\frac{{GDP}_{i}}{{NDL1}_{i}}}$$

$${k}_{i j} = \frac{{M}_{i}}{{M}_{i} + {M}_{j}}$$

where Rᵢⱼ is an economic linkage level between city i and city j; Mᵢ and Mⱼ are comprehensive development quality of the two cities; kᵢⱼ is a modified gravity coefficient; Dᵢⱼ is a shortest highway distance between city i and city j; V is a highway travel speed in a research area; r is a friction coefficient, and according to Gu Chaolin et al.'s study on spatial relations of Chinese urban system in combination with the overview of the region in this embodiment, setting r to 2 is in line with the actual situation; GDPᵢ is simulated GDP of city i; and NDLIᵢ is a night light development index of city i.

### III. Results and Analysis:

### 1. Spatialization Results of GDP in the Chengdu-Chongqing Region and Error Analysis:

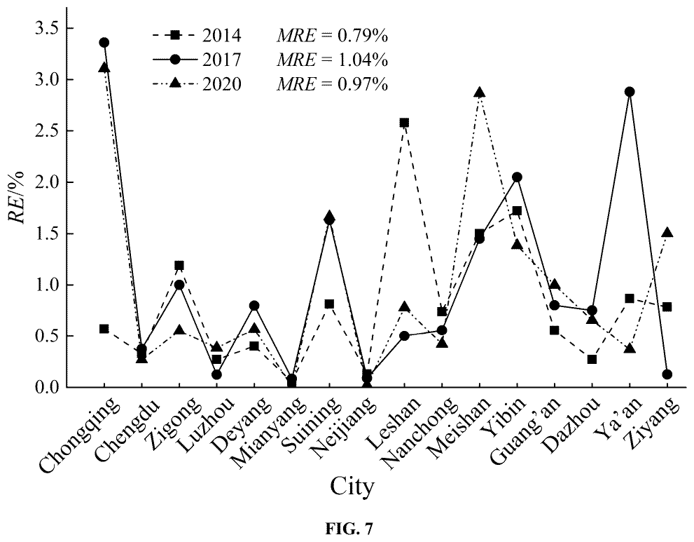

In this embodiment, simulation of GDP₁ and simulation of GDP₂₃ use image data with spatial resolutions of 30 m and 500 m, respectively. Studies have shown that the optimal research scale for provincial and municipal levels is typically between 100 m to 1000 m. Therefore, for standardization purposes, a 500-meter grid scale is selected in this embodiment. To prevent accuracy errors resulting from resampling, data of arable land and woodland types are extracted from the land use data, and spatial locations of the extracted data are mapped to 500-meter grids. A sum of arable land and woodland areas within each grid is calculated, resulting in GDP₁ for each grid. Simultaneously, GDP₃ is calculated for each grid. After the summation of GDP₁ and GDP₂₃ and pixel-wise correction, predicted GDP values are redistributed to each pixel, yielding GDP density maps at a 500 m×500 m resolution for the years 2014, 2017, and 2020. These maps are divided into seven levels using ArcGIS software, as shown in FIG. 7.

From FIG. 7, it can be observed that the economic development in the Chengdu-Chongqing urban agglomeration is good from 2014 to 2020, with a continuous growth trend in GDP density. The proportion of areas in the region with grid GDP exceeding 200 million yuan increased from 0.39% in 2014 to 0.92% in 2020, indicating that the overall development level of the Chengdu-Chongqing region is still relatively low, but it is growing at a rapid rate. Inside the urban agglomeration, one part includes the economic development axis of Mianyang-Deyang-Chengdu-Meishan. Along this axis, there is a higher GDP density, and significant growth changes are observed. Another part includes Chongqing's main urban area and nearby regions like Yongchuan and Tongliang districts, where GDP density growth changes are also noticeable. Both areas mentioned above are extensions of the two core cities of the Chengdu-Chongqing urban agglomeration, indicating that the spillover effects of large cities can lead to rapid development in nearby cities. In terms of individual cities, areas with fast GDP density growth from 2014 to 2020 are primarily in the central urban areas of various cities. Cities with significant growth include Chengdu, Chongqing, Yibin, Mianyang, and Suining. Among prefecture-level cities, Yibin and Mianyang, in particular, showed noticeable changes in GDP density due to their strong performance and rapid development of the secondary and tertiary industries. In contrast, areas with less significant GDP density changes include cities like Neijiang and Zigong, with GDP growth rates of only 26.6% and 35% over the seven-year period, considerably lower than the average growth rate of the urban agglomeration, indicating slow development.

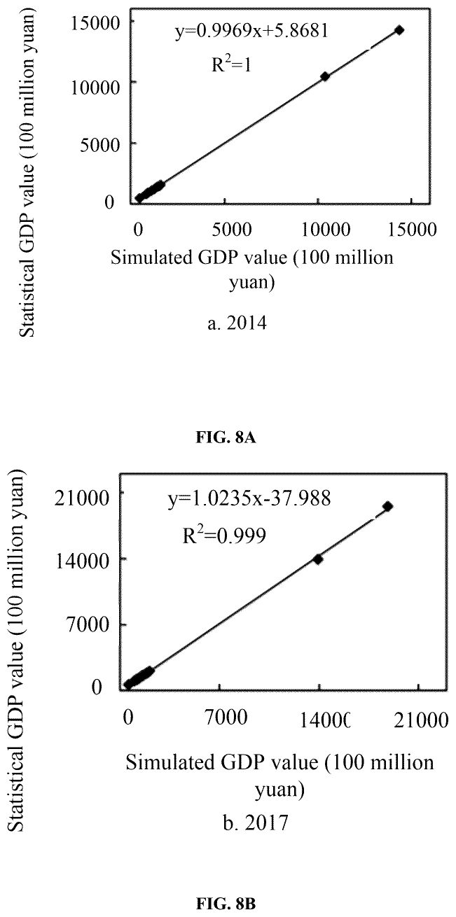

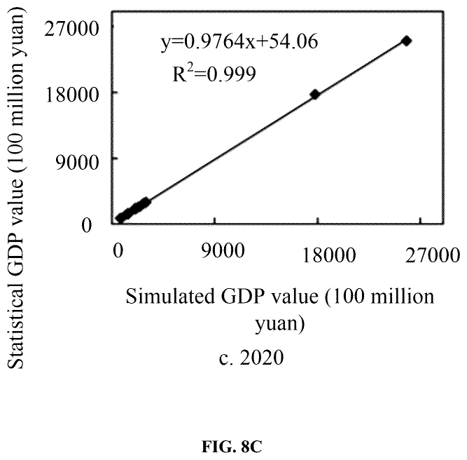

Accuracy of GDP of each prefecture-level city in the Chengdu-Chongqing region for the years 2014, 2017, and 2020 after pixel-wise correction is validated using formulas (8) and (9), and the validation results are shown in FIGS. 8A-8C. Overall, the predicted GDP based on constructed model shows high accuracy for most cities, with RE values all less than 3.5% and MRE values not exceeding 1.1%. The highest RE value during the study period is observed in Chongqing in 2017, reaching 3.3%, with other cities like Leshan, Ya'an, Meishan, and Yibin also experiencing errors exceeding 2%. Cities with better simulation results include Mianyang, Neijiang, Chengdu, and Luzhou, with errors all below 0.4%. While the overall simulation accuracy appears to be high, there are still some problems due to factors such as limited data quality, economic development levels, and industrial structures. For example, the data used in this embodiment is based on a 500-meter grid scale. During grid segmentation, for districts/counties with small administrative areas and strong economic capabilities (such as Yuzhong District and Dadukou District in Chongqing), there will inevitably be a certain degree of error. Overall, although there are cases of higher RE values in some cities, the overall error is not significant, and the fitting results between simulated values and actual values over the three years all exceed 0.99 (FIGS. 8A-8C). Therefore, spatializing GDP based on this model is reliable.

### 2. Analysis of GDP Change Trends in the Chengdu-Chongqing Region:

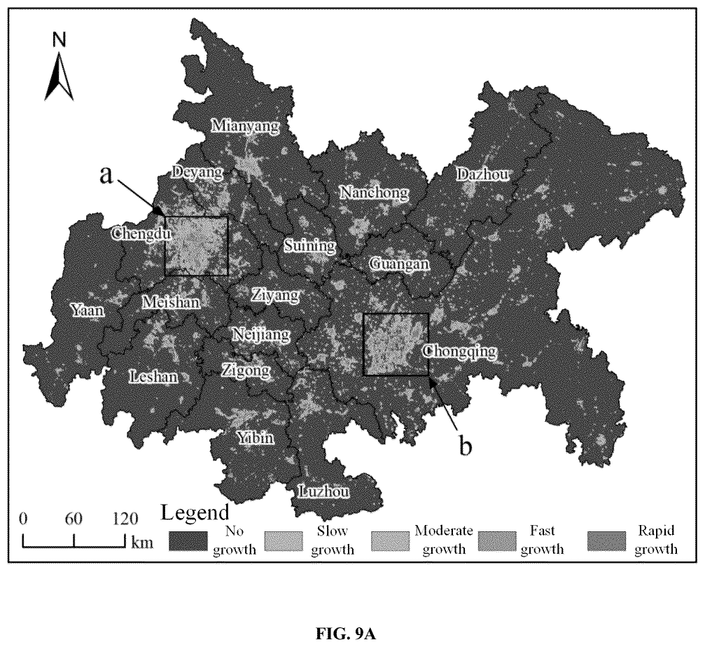

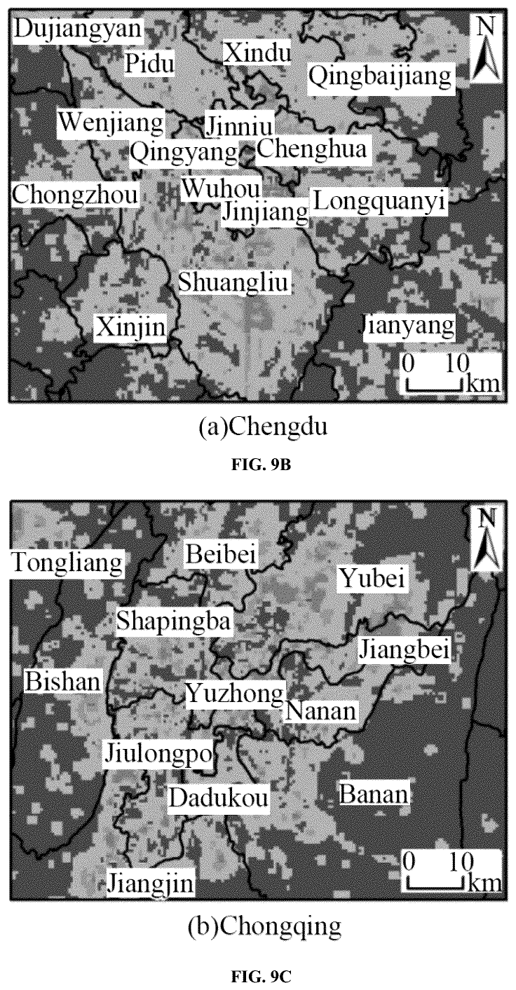

Using trend analysis, the change trends of GDP density in the Chengdu-Chongqing region from 2014 to 2020 are obtained and classified into five categories (as shown in FIGS. 9A-9C) based on the growth status. The classification criteria and the percentage of each category are shown in Table 2.

From FIGS. 9A-9C, it can be observed that areas with significant GDP growth trends in the Chengdu-Chongqing region are roughly distributed in the western region centered around Chengdu and the eastern region centered around Chongqing. This indicates that the economic growth trend in this region is mainly characterized by clustered development and a dual-core driving mode. In terms of the growth range, areas with no growth account for 88.9% of the entire research area. Areas with economic growth account for 11.3%, among which the proportion of areas with slow growth is 7.3%, the proportion of areas with moderate growth is 3.0%, and the proportion of areas with fast growth is only 0.6%, mainly distributed in the main urban areas of Chengdu, Chongqing, and Mianyang. The proportion of areas with rapid growth is only 0.2%, concentrated mainly in Chengdu's Tianfu New District, Qingyang District, Jinjiang District, and Chongqing's Yuzhong District, Jiangbei District, as well as core areas of some other prefecture-level cities. Areas outside of these regions, due to being far from the core development areas of the Chengdu-Chongqing urban agglomeration, exhibit weaker urban development linkage effects and slower growth trends.

TABLE 2
Classification criteria for slope levels and level percentages

| Type | Classification criteria | Percentage/% |
|---|---|---|
| No growth | θ ≤ 0 | 88.9 |
| Slow growth | 0 < θ ≤ 0.1 s | 7.3 |
| Moderate growth | 0.1 s < θ ≤ 0.5 s | 3.0 |
| Fast growth | 0.5 s < θ ≤ 1.5 s | 0.6 |
| Rapid growth | θ > 1.5 s | 0.2 |

Note:
s represents the standard deviation of the research area.

### 3. Analysis of Urban Economic Linkage Strength in the Chengdu-Chongqing Region

By incorporating the nighttime light index into the formula for calculating the comprehensive urban development quality, the comprehensive urban development quality (Mᵢ) of each city in the Chengdu-Chongqing region for the years 2014, 2017, and 2020 is obtained.

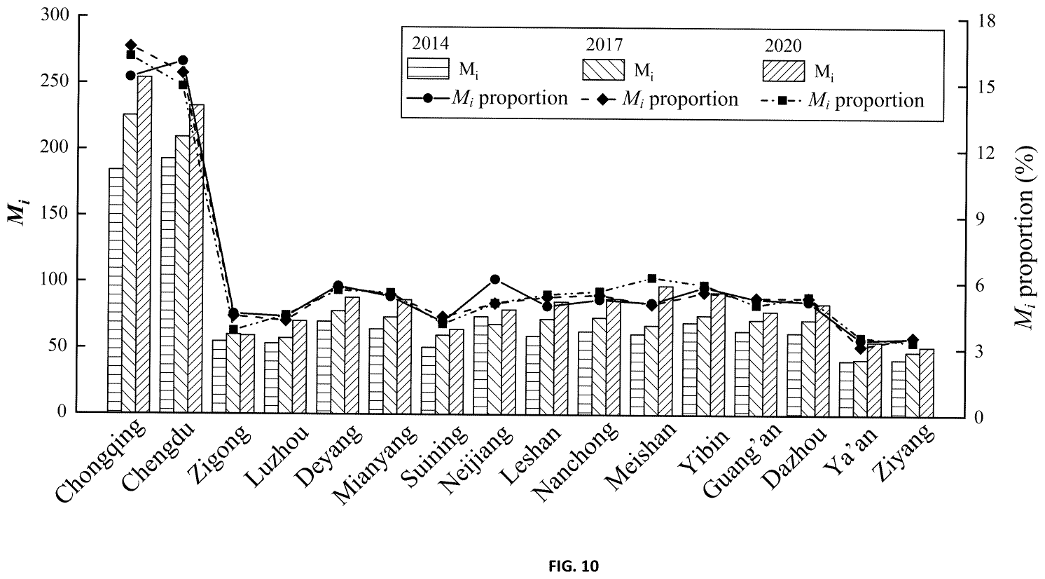

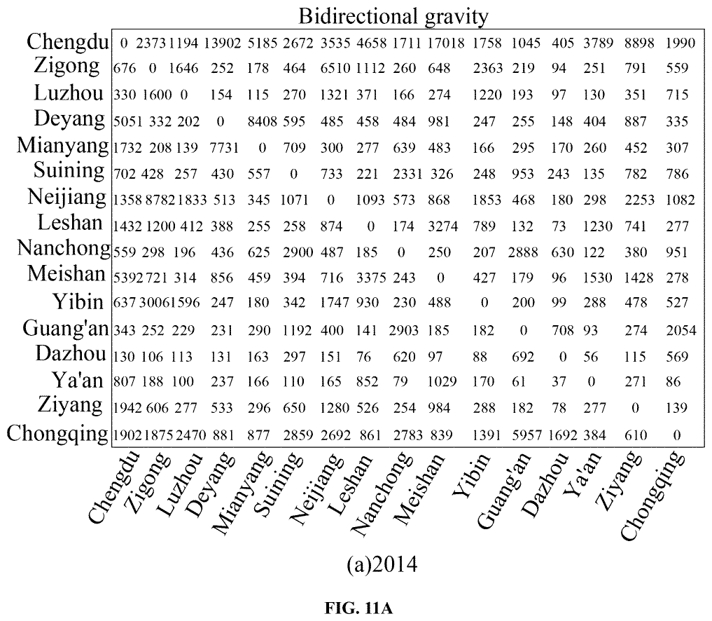

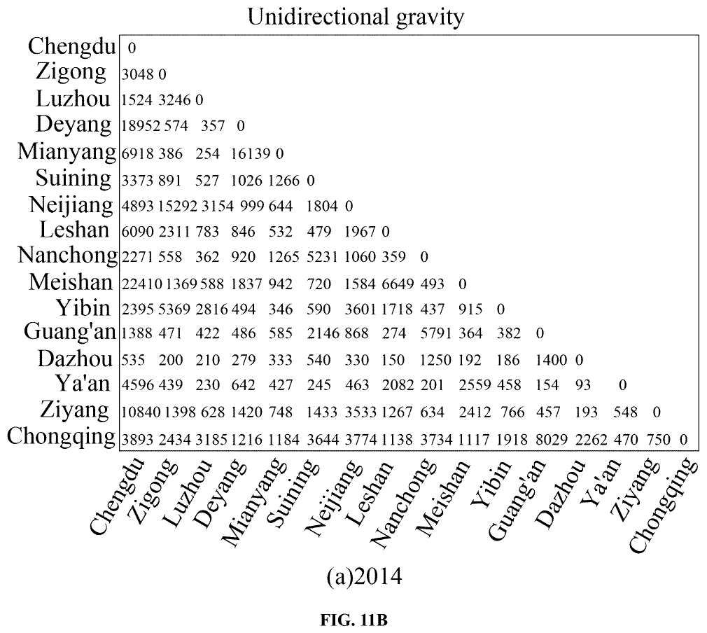

Compared to the traditional comprehensive development quality index, the newly constructed index incorporates the nighttime light index, overcoming shortcomings such as the subjective selection and poor interpretability of the existing urban quality index, thereby better reflecting the degree of balance of development among cities. From FIG. 10, it can be observed that the comprehensive development quality of cities in the Chengdu-Chongqing region shows a steady improvement. The total comprehensive development quality of Chengdu and Chongqing, as the leading cities in the Chengdu-Chongqing urban agglomeration, has a proportion consistently over 30% during the three periods, while the remaining cities each maintain a stable proportion between 3% and 7%. Cities around Chengdu, such as Deyang, Mianyang, and Meishan, exhibit significant increases in Mᵢ, with growth rates of 25.95%, 34.45%, and 59.88%, respectively. This reflects higher influence and attractiveness of the Chengdu circle, represented by Chengdu, within the Chengdu-Chongqing urban agglomeration. Overall, the comprehensive urban development quality in this region exhibits a spatial characteristic with Chengdu and Chongqing leading the way, demonstrating a “dual-core driven development.”

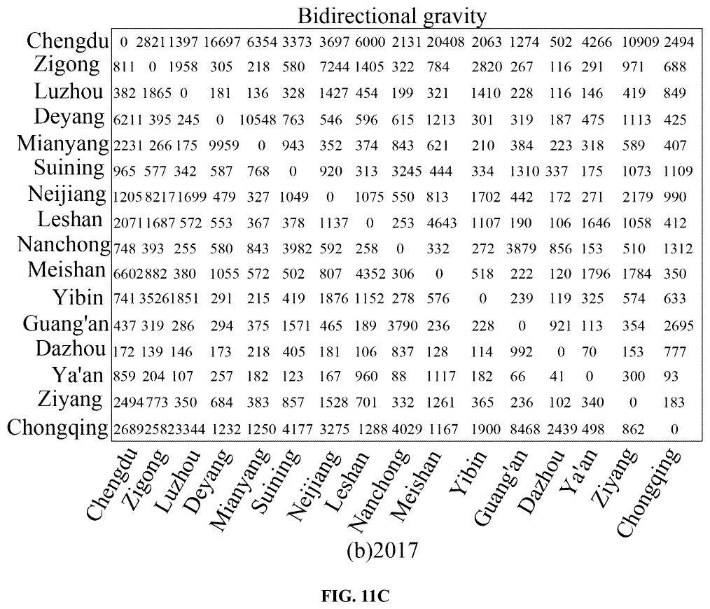

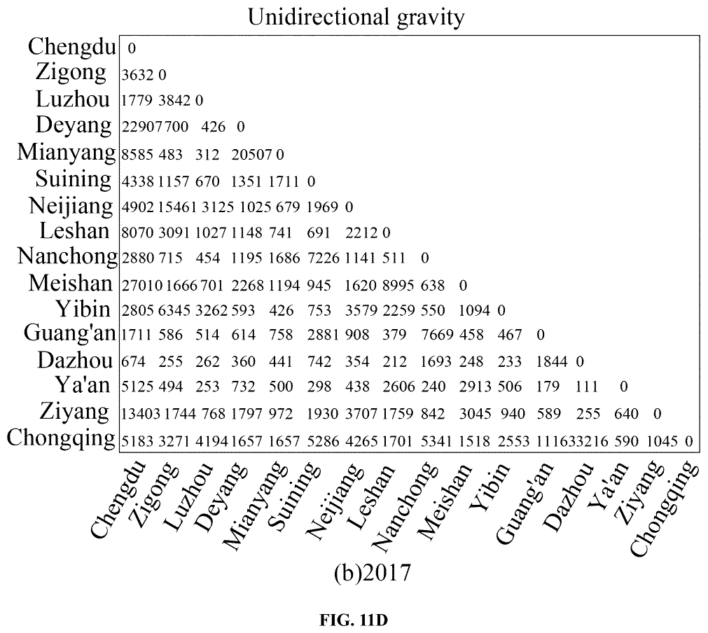

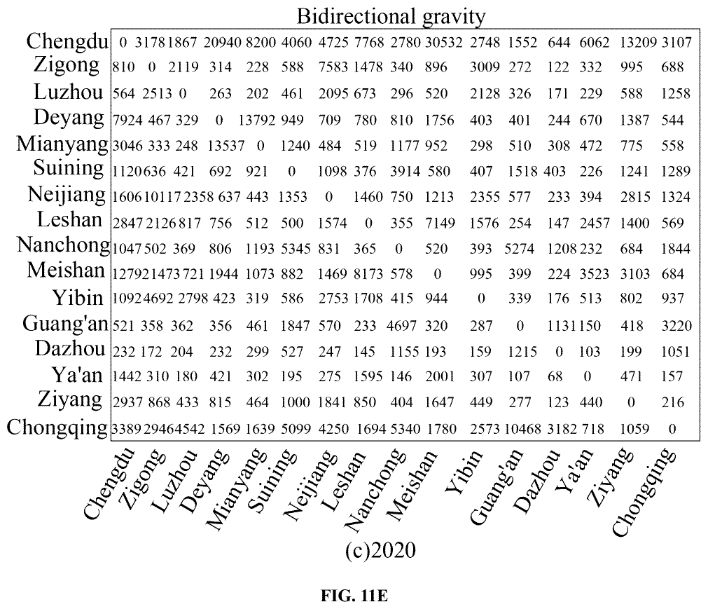

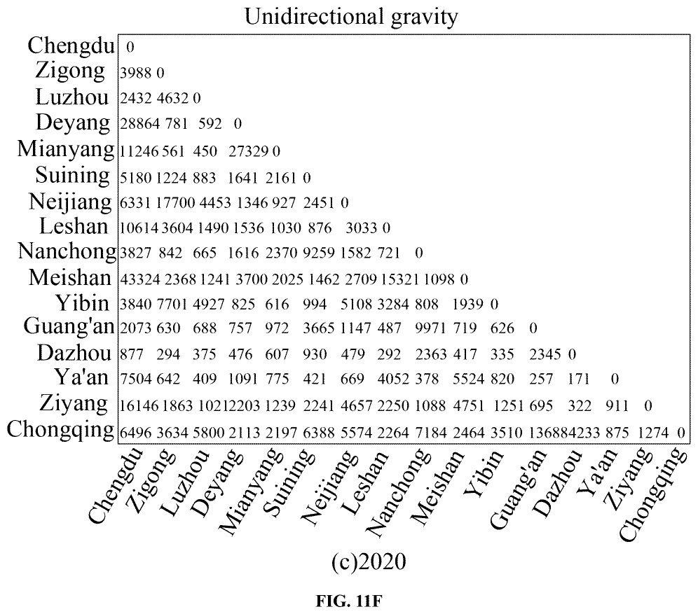

The economic linkage strength between cities in the Chengdu-Chongqing region is calculated using the formula (as shown in FIGS. 11A-11F), with the horizontal and vertical axes representing the year and linkage type, respectively. By using modified gravity coefficient defined by the comprehensive urban development quality, the often overlooked bidirectional gravity differences between cities is made clear. Compared to the unidirectional economic linkage strength between cities, the bidirectional economic linkage strength better reflects the level of economic interaction between cities. For example, in bidirectional gravity, it is evident that the strength of economic linkages from Chengdu to other cities is greater than the strength of economic linkages from other cities to Chengdu. This highlights Chengdu's robust economic activity, a characteristic difficult to capture in a unidirectional gravity model.

Overall, in the bidirectional gravity model, the economic linkage strength between cities in the Chengdu-Chongqing region is steadily increasing, with minor changes in the linkage strength relationship between cities. The total economic linkage strength increased from 261,968 in 2014 to 433,795 in 2020, indicating gradually increasing complexity in the spatial connection network. In terms of individual cities, Chengdu has the strongest economic linkage to Meishan, with the linkage strength increasing from 17,018 in 2014 to 30,532 in 2020, a growth of over 79.4%. Following closely are the linkages to Deyang and Mianyang, with linkage strengths increasing from 8,408 and 7,731 in 2014 to 13,792 and 13,537 in 2020, respectively. Chengdu has the weakest linkage to Dazhou, with a linkage strength of only 232 in 2020. Chongqing has the strongest linkage to Guang'an, increasing from 5,975 in 2014 to 10,468 in 2020, followed by economic linkages to Nanchong and Suining, with spatial linkage strengths reaching 5,340 and 5,099 in 2020, respectively. Apart from the two major cities, some cities within the Chengdu-Chongqing region also exhibit high linkage strengths, such as Zigong and Neijiang, Mianyang and Deyang, and Leshan and Meishan, which have maintained high and steadily increasing linkage strengths since 2014. In summary, the economic linkage level among cities in the Chengdu-Chongqing region is continuously deepening, with Chengdu playing a prominent role in driving nearby cities. However, influenced by factors such as infrastructure and geographical environment, economic linkage strengths between different cities are significantly different, with some cities still experiencing relatively low linkage strengths.

In conclusion, this embodiment utilizes nighttime light data, land use data, and socio-economic data to spatialize the GDP of the Chengdu-Chongqing region for the years 2014, 2017, and 2020. Using trend analysis in combination with a modified gravity model improved based on the nighttime light index, the economic development characteristics of the Chengdu-Chongqing urban agglomeration are analyzed at the pixel scale and in terms of economic linkages. Main conclusions:

1. The GDP spatialization model constructed based on the nighttime light data and land use data is relatively accurate, with an average relative error of around 1%. The output value of GDP₁ shows a strong correlation with the land use data, and the total nighttime light (TNL) constructed using nighttime light data has the strongest correlation with the output value of GDP₂₃. The GDP spatialization model, incorporating both GDP₁ and GDP₂₃, demonstrates high accuracy and can reflect the distribution of GDP at the pixel level.

2. The core area of the Chengdu-Chongqing urban agglomeration has experienced rapid development, and 73.9% of areas with rapid growth in GDP density are located in Chengdu and Chongqing. The trend analysis gives the GDP growth trend in the Chengdu-Chongqing region from 2014 to 2020. The results indicate that areas with fast economic growth in the Chengdu-Chongqing region are primarily located in Chengdu, Chongqing, and some surrounding counties (cities/districts).

3. In this embodiment, on the basis of the existing correction approach for the gravity model, the nighttime light index, which can represent the degree of balance of economic and social development within each, is introduced into the comprehensive urban development quality, and is used as an influential coefficient to modify the traditional gravity model. The study that utilizes the economic linkage strength to measure regional economic interaction provides new perspectives for studying the level of economic interaction, offering reference for the optimization of regional economic spatial structures. The case analysis suggests that the economic linkage strength among cities in the Chengdu-Chongqing region is continuously deepening, with the comprehensive urban development quality steadily improving. Chengdu, as one of the “root” cities of the Chengdu-Chongqing urban agglomeration, holds a central position in the urban economic network, profoundly influencing the nearby cities in terms of supply and demand relationships.

This embodiment only uses NPP/VIIRS data; future research can incorporate DMSP/OLS data to construct a GDP spatialization model with a longer time series, better reflecting the dynamic changes in the development of the Chengdu-Chongqing region over a longer period. The study considers only the relationship of nighttime light and land use with GDP, while GDP is influenced by numerous factors. Future research can introduce more variables, such as population, Points of Interest (POI), etc., to further enhance the accuracy of GDP spatialization.

The economic linkage between cities is a complex process influenced by various factors. After exploration of the strength of regional economic linkages, understanding the driving factors of the linkages, including other factors such as policies, industries, public services, etc., is a potential direction for future breakthroughs. Regional economic coordinated development is an ongoing process. The analysis is limited to characterizing the economic network of the Chengdu-Chongqing region. Therefore, analyzing economic network linkages between surrounding prefecture-level cities and even provinces is a focus for further study of understanding the development potential and direction of the Chengdu-Chongqing region.

The above embodiments are merely illustrative of some implementations of the present disclosure, and the description thereof is specific and detailed, but should not be construed as limiting the patent scope of the present disclosure. It should be noted that those of ordinary skill in the art can further make several variations and improvements without departing from the concept of the present disclosure, and all of these fall within the protection scope of the present disclosure.

What is claimed is:

1. A method for analyzing changes in urban economic development characteristics of an urban agglomeration based on nighttime light remote sensing, comprising the following steps:
step 1: building a Gross Domestic Product (GDP) spatialization model: spatializing GDP of an urban agglomeration region by using an industry-based modeling approach, modeling spatialization of a primary industry output GDP₁ with land use data, and modeling spatialization of a secondary and tertiary industry output GDP₂₃ by selecting an optimal light index on the basis of nighttime light data;
step 2: measuring an increase or a decrease of a specific variable over time at a pixel level using trend analysis, which is specifically as follows:
$${θ}_{slope} = \frac{n \times {\sum }_{i = 1}^{n} ( i \times {GDP}_{i} ) - {\sum }_{i = 1}^{n} i {\sum }_{i = I}^{n} {GDP}_{i}}{n \times {\sum }_{i = 1}^{n} {i}^{2} - {( {\sum }_{i = 1}^{n} i )}^{2}}$$
wherein θₛₗₒₚₑ represents a slope of a univariate linear regression equation for year-to-year change of GDP in a corresponding time period at a current pixel, n represents a detection time span in years, and GDPᵢ represents a GDP value of year i;
step 3: modifying a gravity model that reflects an economic linkage strength between cities: modifying a gravity constant based on a ratio of comprehensive quality of one city to total comprehensive quality of two cities; expressing a spatial distance between the cities in the form of a time distance; reflecting a degree of balance of economic and social development within each city by using a night light development index (NLDI); and for each city, using GDP and a reciprocal of the NLDI as a measure of comprehensive urban development quality:
$${R}_{i j} = {k}_{i j} \frac{{V}^{r} {M}_{i} {M}_{j}}{{D}_{i j}^{r}}$$
$${M}_{i} = \sqrt{\frac{{GDP}_{i}}{{NDLI}_{i}}}$$
$${k}_{i j} = \frac{{M}_{i}}{{M}_{i} + {M}_{j}}$$
wherein Rᵢⱼ is an economic linkage level between city i and city j; Mᵢ and Mⱼ are comprehensive development quality of the two cities; kᵢⱼ is a modified gravity coefficient; Dᵢⱼ is a shortest highway distance between city i and city j; V is a highway travel speed in a research area; r is a friction coefficient; GDPᵢ is simulated GDP of city i; NDLIᵢ is a night light development index of city i.

2. The method for analyzing changes in urban economic development characteristics of an urban agglomeration based on nighttime light remote sensing according to claim 1, wherein in step 1, said modeling the spatialization of the primary industry output GDP₁ with the land use data comprises:
modeling GDP₁ by selecting arable land and woodland, specifically as follows:
$${GDP}_{1 n} = a \cdot {S}_{c}$$
wherein GDP₁ₙ is a primary industry output of year n; S_{c} is a sum of arable land and woodland areas; and a is a coefficient of a regression model.

3. The method for analyzing changes in urban economic development characteristics of an urban agglomeration based on nighttime light remote sensing according to claim 1, wherein in step 1, said modeling the spatialization of the secondary and tertiary industry output GDP₂₃ by selecting the optimal light index on the basis of the nighttime light data comprises:
calculating nighttime light indices for multiple prefecture-level cities over multiple years in the urban agglomeration region, and performing regression analysis on the nighttime light indices with respect to GDP₂₃ to select the optimal light index, wherein a specific parameter model is as follows:
$${GDP}_{23 n} = {P}_{0} + a \times {Q}_{i}$$
wherein GDP₂₃ₙ represents a secondary and tertiary industry output of year n; P₀ is a constant; a is a coefficient of a regression model; and Qᵢ represents light indices; and
calculating nighttime light indices over the years, performing correlation analysis on the nighttime light indices and GDP₂₃, and selecting a light index with a highest correlation to establish a regression model with GDP₂₃.

4. The method for analyzing changes in urban economic development characteristics of an urban agglomeration based on nighttime light remote sensing according to claim 2, wherein in step 1, said modeling the spatialization of the secondary and tertiary industry output GDP₂₃ by selecting the optimal light index on the basis of the nighttime light data comprises:
calculating nighttime light indices for multiple prefecture-level cities over multiple years in the urban agglomeration region, and performing regression analysis on the nighttime light indices with respect to GDP₂₃ to select the optimal light index, wherein a specific parameter model is as follows:
$${GDP}_{23 n} = {P}_{0} + a \times {Q}_{i}$$
wherein GDP₂₃ₙ represents a secondary and tertiary industry output of year n; P₀ is a constant; a is a coefficient of a regression model; and Qᵢ represents light indices; and
calculating nighttime light indices over the years, performing correlation analysis on the nighttime light indices and GDP₂₃, and selecting a light index with a highest correlation to establish a regression model with GDP₂₃.

5. The method for analyzing changes in urban economic development characteristics of an urban agglomeration based on nighttime light remote sensing according to claim 3, wherein the light indices comprise total nighttime light (TNL), average light intensity (ALI), and compounded night light index (CNLI):
$$NL = {\sum }_{i = 0.3}^{D {N}_{max}} ( {DN}_{i} \times {n}_{i} )$$
$$ALI = \frac{TNL}{{DN}_{max} \times N}$$
$$S = \frac{{A}_{N}}{A}$$
$$CNLI = ALI \times S$$
wherein DNᵢ and nᵢ represent a grayscale pixel value and the number of pixels at an i-th level within an administrative unit, respectively; DNₘₐₓ represents a maximum pixel value within the administrative unit; N is a total number of pixels with light values in a range of [0.3, DNₘₐₓ] within the region; S is a light area ratio; A_{N} represents an area occupied by the pixels in the range of [0.3, DNₘₐₓ] in the administrative unit, and A represents an area of the administrative unit.

6. The method for analyzing changes in urban economic development characteristics of an urban agglomeration based on nighttime light remote sensing according to claim 4, wherein the light indices comprise total nighttime light (TNL), average light intensity (ALI), and compounded night light index (CNLI):
$$NL = {\sum }_{i = 0.3}^{{DN}_{max}} ( {DN}_{i} \times {n}_{i} )$$
$$ALI = \frac{TNL}{{DN}_{max} \times N}$$
$$S = \frac{{A}_{N}}{A}$$
$$CNLI = ALI \times S$$
wherein DNᵢ and nᵢ represent a grayscale pixel value and the number of pixels at an i-th level within an administrative unit, respectively; DNₘₐₓ represents a maximum pixel value within the administrative unit; N is a total number of pixels with light values in a range of [0.3, DNₘₐₓ] within the region; S is a light area ratio; A_{N} represents an area occupied by the pixels in the range of [0.3, DNₘₐₓ] in the administrative unit, and A represents an area of the administrative unit.

7. The method for analyzing changes in urban economic development characteristics of an urban agglomeration based on nighttime light remote sensing according to claim 5, wherein step 1 further comprises linear correction of GDP, and under the condition of ensuring that total actual statistical GDP of all cities in the urban agglomeration remains unchanged, pixel-wise correction is performed using the following formula:
$${GDP}_{T} = {GDP}_{j} \times ( {GDP}_{t} / {GDP}_{a l l} )$$
wherein GDP_{T} is a simulated GDP value after the pixel-wise correction; GDPⱼ is an initial simulated value for each pixel; GDPₜ is an actual statistical GDP value of each city; and GDPₐₗₗ is a total simulated GDP value of all the cities.

8. The method for analyzing changes in urban economic development characteristics of an urban agglomeration based on nighttime light remote sensing according to claim 6, wherein step 1 further comprises linear correction of GDP, and under the condition of ensuring that total actual statistical GDP of all cities in the urban agglomeration remains unchanged, pixel-wise correction is performed using the following formula:
$${GDP}_{T} = {GDP}_{j} \times ( {GDP}_{t} / {GDP}_{a l l} )$$
wherein GDP_{T} is a simulated GDP value after the pixel-wise correction; GDPⱼ is an initial simulated value for each pixel; GDPₜ is an actual statistical GDP value of each city; and GDPₐₗₗ is a total simulated GDP value of all the cities.

9. The method for analyzing changes in urban economic development characteristics of an urban agglomeration based on nighttime light remote sensing according to claim 7, further comprising verifying accuracy of the GDP after pixel-wise correction by using a relative error (RE) and a mean relative error (MRE):
$$RE = ( \vert \frac{{GDP}_{s} - {GDP}_{A}}{{GDP}_{A}} \vert ) \times 100 \%$$
$$MRE = \frac{1}{n} RE$$
wherein GDP_{S} represents a simulated GDP value, GDP_{A} represents an actual statistical GDP value, and n is the number of prefecture-level cities.

10. The method for analyzing changes in urban economic development characteristics of an urban agglomeration based on nighttime light remote sensing according to claim 8, further comprising verifying accuracy of the GDP after pixel-wise correction by using a relative error (RE) and a mean relative error (MRE):
$$RE = ( \vert \frac{{GDP}_{s} - {GDP}_{A}}{{GDP}_{A}} \vert ) \times 100 \%$$
$$MRE = \frac{1}{n} RE$$
wherein GDP_{S} represents a simulated GDP value, GDP_{A} represents an actual statistical GDP value, and n is the number of prefecture-level cities.
